(19) United States
(12) Patent Application Publication
(10) Pub. No.: US 2008/0203604 A1
(43) Pub. Date: Aug. 28, 2008

(54) Wood and Non-Wood Fibers Hybrid Composition and Uses Thereof

(76) Inventor: Jocelyn Lalancette, Quebec (CA)

Correspondence Address: OGILVY RENAULT LLP, 1981 MCGILL COLLEGE AVENUE, SUITE 1600, MONTREAL, QC, H3A2Y3, CA

(21) Appl. No.: 11/814,315

(22) PCT Filed: Jan. 23, 2006
(86) PCT No.: PCT/CA06/00089

§ 371 Date: Jul. 19, 2007

Related U.S. Application Data
(60) Provisional application No. 60/644,995, filed on Jan. 21, 2005.

(51) Int. Cl. D21J 1/08; B27N 3/10; B32B 21/02; B32B 9/02; B32B 7/12

(52) U.S. Cl. 264/122; 252/183.11; 524/14

(57) ABSTRACT

The present invention relates to a composition comprising a mixture of wood particles and non-wood plant particles for the manufacture composite boards or the like. The present invention also relates to methods of preparing composite boards. As described herein, the composition allows the production of panels, boards or logs that can be used in the construction of buildings, houses and furniture.

The present invention relates to the field of composite boards, and particularly to composition for making composite boards.

### BACKGROUND OF THE INVENTION

It is generally admitted in the art that composite boards (particle boards and fiber boards) comprise lignocellulosic material such as wood chips, wood fibers or wood particles bound together with an adhesive binder and/or others chemical agents. Composite boards are formed by layering a mixture of the lignocellulosic material and the resin as wells as additives into a mat, consolidating this mat under pressure (usually in a press or mould), and curing the resin of the board by applying heat (during the consolidation of the mat or subsequently).

Examples of composite boards include low density fiber (LDF), medium density fiber (MDF) and high density fiber (HDF) boards. The lignocellulosic material of these boards usually comprises wood fibers, wood particle, wood chips and oriented stand boards (OSB) in which wood flakes are utilized and constituted by particles. In each of these board types, the lignocellulosic material may be of varying sizes throughout the board.

The physical properties (specific gravity, moisture content, linear expansion, dimensional stability, size and appearance of the board, thickness swelling, etc.) and mechanical properties (internal bond, bending, compression, screw and nail resistance, hardness, shearing strength, falling ball impact and others) of any particular board, can be modified by utilizing different types of resins, changing the resin loading, utilizing more or less resin, modifying the pressing strategies or mat construction or by utilizing other additives amongst other factors known in the art of board making.

The density of any particular board can be readily modified by changing the processing conditions. These conditions include the amount and type of resin and lignocellulosic fiber type and composition used, and the pressure under which the composite mixture is compressed while the resin is being cured. Standard particle boards and fiber boards currently manufactured range in density from about 100 to 1,000 kg/m³.

Many boards are manufactured using binders or thermo-set resins which have specific heat sensitivity. Mechanical and physical characteristics of any particular board can be influenced by the extent to which the resin is cured during the manufacturing process. The primary means for curing the resin in such boards is applying heat while the board is being compressed. Standard board presses utilize wide heated plates which transfer heat to the board during compression. While this heat is effective in curing the resin towards the surface of the board, it is less effective in curing the resin present in the core or centre of the board. Steam is the main heat transfer medium to the core. The temperature of the steam must be between 100° C. and 175° C. even when the plate temperature is significantly higher.

Nowadays, particle board, fiberboard, and the like as well as lumber, plywood, veneer, and combined materials are used as wood-based building materials, furniture materials, display materials, sound absorbing materials, and various handicraft materials. Also, rigid materials or foamed materials of synthetic resin, such as polystyrene, polyethylene, polyurethane, phenol resin, melamine resin, and urea resin are used as display materials, sound absorbing materials, and heat insulating materials and the like. The use of such materials will depend on their wood source and their petroleum source. Lumber and plywood are made of wood and have high material strength and dimensional stability. But the proportion of wood in these materials can be so small that they loose some of the wood's characteristic.

Wood materials, such as lumber, plywood, particleboard, and fiberboard and the like, which have been widely used very much as building materials, are respectively made of round wood or by products from lumber manufacturing process, mainly natural wood. With recent exhaustion of wood source, manufacturers are looking for alternative solutions. Consequently, it appears to be impossible to completely satisfy high demand of wood in future, and the price of wood will substantially raise.

Foamed materials of synthetic resin, such as polystyrene, polyethylene, polyurethane, and phenol resin are light, have good workability and excellent heat insulation, so that they are widely used as a display material and heat insulation material. The resins in these materials are of a petroleum source, which is a very limited resource, and therefore it is adds an additional limitation to the production of wood panels and boards through the conventional techniques.

Considering the state of the art described above, it is still highly-desirable to be provided with new compositions and methods for preparing solid structures under the form of panels or construction boards.

### SUMMARY OF THE INVENTION

One aim of the present invention is to provide compositions for preparing composite boards. According to one embodiment, the present invention provides a composition comprising non-wood plant particles, wood particles and an adhesive component capable of binding to the non-wood particles and to the wood particles. Such composition can be used, for example, for preparing composite boards or panels.

In an embodiment, the non-wood plant particles are non-wood plant fibers. The fibers can be obtained, for example, from a non-wood plant leaf.

In another embodiment, the composite board can have a density of between about 100 to 1,000 kg/m³, preferably of between about 250 to 750 kg/m³, and most preferably of between about 400 to 700 kg/m³.

In an embodiment, the wood particles can be wood fibers. In a further embodiment, the wood particles can comprise a lignocellulosic material.

In a further embodiment, the non-wood plant particles can be in proportion of 1 to 99% with respect to total particles at the composition, but also in proportion of 10 to 90%. In yet another embodiment, the non-wood plant particles can have a density of about 0.15 to 1 g/cm³.

In another embodiment, the composite board can also have an internal bonding strength of between about 0.5 to about 1 MPa, a modulus of rupture of between about 10 to about 60 MPa, a modulus of elasticity of between about 1,000 to about 7,000 MPa, a thick swelling index of between about 1 to about 20% (preferably of between about 5 to about 15%), a water absorption index of between about 1 to about 40% (preferably of about 5 to 20%), and/or a linear expansion index of between about 0.05 to about 5%. In another embodiment, the humidity index of the mat comprising the composition before pressing is between about 2 to about 20%. It will be recognized by the skilled artisan that the composite board prepared with the composition described herein can be a low density fiber board, a medium density fiber board or a high density fiber board.

According to another embodiment, the non-wood plant particles originate from a source selected from the group consisting of abaca, hemp, agel, gebang palm, bagasse, sugar cane, bamboo, banana leaves and stems, caranguata, caroa, coir, coconut, corn, cotton, esparto grass, flax, giant reed, henequen, maguey, cantala, zapupe, Salvador sisal, Mexican sisal, sasal, hesperaloe, jusi, jute, kapok, kenaf, mautirius hemp, pipeira, fique, milkweed, New Zealand hemp, olona, papyrus, piassaya, para grass, ramie (china grass), rice, sunn, switchgrass, tata cloth, wheat, barley, straw, oat, grain sorghum, amaranth, and any cereal straw or any other agricultural plant and non-wood plant fibers. In a further embodiment, the non-wood plant particles originate from corn.

The preferred form given or produced with the composition of the present invention is a pressed board or panel or moulded structures. Different possible forms can be obtained or given to the structure, panel or board. For example, the composition can be pressed into a log cast and can tale a log-like structure. The structure, panel or board will be preferably rigid or solid.

The adhesive component described herein can comprise a formaldehyde derivative adhesive, such as, but not limited to, phenol, urea, or melamine urea-formaldehyde. Alternatively, the adhesive component can also be an isocyanate resin. The adhesive component can comprise between about 1 to about 10% of a wax. In a further embodiment, the proportion of adhesive component in the composition is between about 1 to about 20%.

According to another embodiment, the composition for preparing the composite board comprises non-wood particles, wood particles and an adhesive component. The non-wood plant particles may be in a proportion of 1 to 99% with respect to the total particles content of the composite board and have a density of between about 0.15 to about 1 g/cm³. The wood particles can comprise lignocellulosic material. The adhesive component can be capable of binding the non-wood plant particles and the wood particles, can comprise a formaldehyde derivative adhesive or a isocyanate resin, can be in a proportion of between about 1 to about 20% with respect to the composition, and can comprise between about 1 to about 10% (w/w) of a wax. The composite board prepared with this composition can have a density of between about 100 to about 1,000 kg/m³, an internal bonding of between about 0.5 to about 1 MPa, a modulus of rupture of between about 10 to about 60 MPa, a modulus of elasticity of between about 1,000 to about 7,000 MPA, a thick swelling index of between about 1 to about 20%, a water absorption of between about 1 to about 20%, and a linear expansion index of between about 0.05 to about 0.5%.

According to another object of the invention, there is provided a method of producing a composite board comprising the steps of (a) preparing a mat with the compositions described herein and (b) pressing the mat at a temperature and for a sufficient time to obtain the composite board.

Also one object of the invention is to provide a composite board prepared with the composition described herein.

Another object is the use of the composition as described herein in the manufacture of composite boards.

For the purpose of the present invention the following terms are defined below.

The terms “non-wood particles” or “non-wood fibers” are used herein to mean any particles or fibers of vegetable origin except particles or fibers of wood origin. This may include any agricultural fibers or particles, annual crops fibers or particles thereof, or other sources more or less exotic, such as non-wood plants.

### DESCRIPTION OF THE PREFERRED EMBODIMENT

The present invention now will be described more fully hereinafter. This invention, may, however, be embodied in many different forms and should not be construed as limited to the embodiments set forth herein; rather, these embodiments are provided so that this disclosure will be thorough and complete, and will fully convey the scope of the invention to those skilled in the art.

In accordance with the present invention, there is provided a composition comprising a mixture of non-wood plant particles (such as non-wood plant fibers or part thereof) and wood particles (such as wood fibers) and an adhesive component. The composition can be used in the preparation of panels and composite boards.

The invention presented herein challenges the current paradigm of managing the Earth's diminishing forests primarily for timber) at the cost of all other essential goods and services that forests provide to humanity. Much of this wood is wasted through inefficient production technologies, unnecessary applications and a failure to recover usable materials from the waste stream.

The non-wood plant sources of fibers or particles that can be used in the preparation of the composition described herein can be derived from, for example, abaca, hemp, agel, gebang palm, bagasse, sugar cane, bamboo, banana leaves and stems, caranguata, caroa, coir, coconut, corn, cotton, esparto grass, flax, giant reed, henequen, maguey, cantala, zapupe, Salvador sisal, Mexican sisal, sasal, hesperaloe, jusi, jute, kapok, kenaf, mautirius hemp, pipeira, fique, milkweed, New Zealand hemp, olona, papyrus, piassaya, para grass, ramie (china grass), rice, sunn, switchgrass, tata cloth, wheat, barley, straw, oat, grain sorghum, amaranth, and any cereal straw or any other source of agricultural and non-wood fibers and/or particles thereof. The non-wood plant particles can also be derived from corn.

The ratio between each source of fibers will depend on the characteristics of the final product. For example, but without limitation, the fibers of some plants can confer more rigidity to a panel, while others give a higher resistance to extension pressures or to humidity.

The person skilled in the art will also recognize that different parts of the non-wood plant can be used in the preparation of the composition. These parts include, but are not limited to, basts, seeds, roots and/or leaves.

The non-wood plant fibers of the composition also can have themselves a density of 0.1 to 2 g/cm³, preferably of 0.15 to 1 g/cm³.

Of course, the skilled artisan will recognize that the non-wood plant particles can be processed before their introduction into the composition of the invention. For example, but not limited to, the non-wood plant particles can be roughly or finely minced, crushed, grinded, or handily broken up. The technique used to process the particles can be dictated by, for example, the size and shape of the particles in the final product.

Advantages of the composition of the present invention are to provide the panels or boards with a higher resistance to humidity and water, a higher strength (including bending strength), a higher anticorrosion property, and a fire-retarding property. In addition, the composition described herein are significantly less costly than equivalent products available on the market.

The compositions described herein are more rigid when compared to compositions made up of wood only.

The compositions described herein can be used to manufacture chipboard, fiberboard, and/or oriented strand board. The boards prepared with the composition described herein can be used, for example, for flooring, ceiling, in the manufacture of furniture as well as for interior and exterior construction. These boards can also be used as fiber boards (density ranging from (LDF), low density fiber boards to (HDF), high density fiber boards), wall boards, laminated flooring or panels.

Also, among characteristics of the present invention, when various kinds of shape of the pressing molds are suitably selected, it is possible to manufacture any structure of any shape in addition to plate-like or pillar-like material. The resulting panel of board can have different physical characteristics, including a density varying of between about 100 to about 1,000 kg/m³, and preferably of between about 250 to about 750 kg/m³, and most preferably of between about 400 to about 700 kg/m³. The boards prepared with the compositions described herein can have, for example, an internal bonding strength of 0.5 to 1 MPa, a modulus of rupture of 10 to 60 MPa, a modulus of elasticity resistance strength of 500 to 7,000 MPa, a thick swelling index of 1 to 20% (preferably of 5 to 15%), a water absorption index of 1 to 40%, (preferably of 10 to 20%), a humidity level (or humidity index) of 1 to 20% (preferably of 5 to 18%) and/or a linear expansion index of 0.05 to 0.5%. These mechanical characteristics or physical parameters are measured according to well known techniques in the art, according to the ASTM D1037 and D5651 standard test methods.

An advantage of the method of the present invention is that the consumption of energy for the production of panels or boards with mixture of lignocellulosic from wood and non-wood derivatives, is less than the consumption of energy necessary for known panels or boards produced solely with wood.

Still another advantage of this invention is that the supply of non-wood plant derivatives, particularly fibers, is an annually renewable waste material from the transformation of raw material. In contrast, wood which is not a recuperated waste material, has many other applications and requires many decades before it can be used in the industry.

In one embodiment of the present invention, there is provided low to high density boards made up with non-wood plant fibers mixed with wood material. The non-wood plant fibers and wood material mixtures are then rendered cohesive by addition of an adhesive component. Several adhesive components are known in the art of construction panels and boards for forming a relatively pasty composition, that can be processed to a desired form or design, with a targeted firmness and density. The density of the panels or composite boards may vary between 100 to 1,000 kg/m³, but is preferably of between 640 to 995 kg/m³. The adhesive component can be for example, but not limited to, phenol-formaldehyde, isocyanate resin, or a mixture thereof. In another embodiment, the adhesive component can comprise some wax, or paraffin, in proportion of 0.1 to 10%, again depending on the needs.

According to another embodiment of the present invention, the ratio of non-wood plant particles/wood particles (containing lignocellulosic materials or not), is adjusted depending on the needs. The proportion of non-wood plant particles, such as fibers for example, may be of between 2.5 to 97.5%, with inverse proportion of wood fibers and lignocellulosic materials. Preferably, the proportion of non-wood plant particles is of between about 1% to 100%. Preferably, the non-wood plant fibers or particles are found in the composition or panel or board in proportion of between of 5 to 95%.

The wood (cellulose) material can be utilized in the form of wood chips, flakes, fibers or particles. For good adhesion of the weak acid to this material prior to the application of the synthetic resin, plastic or other binder, it is preferred that the cellulose material, or the wood particles, has a fairly low moisture content. After the cellulose material has been blended with the resin and, in some cases with weak acid, the moisture content of the cellulose material can be of between about 1 to 15% (this percentage is based on the weight of moisture to the dry weight of all other components in the blend).

The composition of the board obtained according to the method of this invention may further comprise, for example, from 2 to 30% (preferably between 4 to 20%) of a glue or resin selected from the group consisting of melamine resins and urea formaldehyde and the like. The rest of the composition comprises non-wood particles as well as wood particles (such as vegetable fibers and lignocellulosic materials and additives).

Of particular interest, the invention has a desired consistency ranging from liquid consistency to a solid consistency. The composition with liquid, or pasty consistency can be prepared and sold as such. Alternatively, the composition can be processed to give a rigid structure, such as panel or boards.

While the present invention has application to the manufacture of standard particle and fiber boards and improving the strength of such products, it also has particular application in the manufacture of fire retardant composite boards. Composite boards which simply comprise cellulose material and resin are highly flammable. As a result, various efforts have previously been made to incorporate a fire retardant within such composite boards so to improve their safety when used in building.

The present invention will be more readily understood by referring to the following examples which are given to illustrate the invention rather than to limit its scope.

### Example I

### Preparation of an Oriented Stand Board (OSB) with Corn Fibers

Three layers (a face layer a, a center layer b and face layer c opposite to layer a), boards where prepared. 20% of the total particle material is present in layer a, 60% in layer b, and 20% in layer c. The control panels comprise 0% of non-wood plant fibers. Poplar and roughly minced corn pieces where added to each layer. Both face layers a and c contain each one 10% of corn fibers (the remaining particles are poplar fibers). Center layer b comprises either 0, 25, 50, 75, or 100% corn fibers, (the remaining particles are poplar fibers). An adhesive component consisting in 3.5% phenol-formaldehyde, 1% of wax and 9.2% humidity was added to fiber mixtures to give the face layers (a and c), and 4.0% isocyanate resin, 1% wax at 5,2% humidity was used for the center layer (b). The boards were prepared under pressure for a period of 170 sec. at 200° C.

Analysis were performed according to the ASTM D1037 test methods.

Table 1 shows the mean values of the different parameters tested for each concentration of corn fibers.

TABLE 1
Mean values of physical parameters of board prepared
with different concentrations of corn fibers.

| | | | Modulus | Modulus | | | |
|---|---|---|---|---|---|---|---|
| Concentration | | Internal | of | of | Thick | | Linear |
| of corn fibers | Density | bounding | resistance | elasticity | swelling | Absorption | expansion |
| in layer b (%) | (Kg/m³) | (MPa) | (MPa) | (MPa) | (%) | (%) | (%) |
| 0 | 713 | 0.84 | 36 | 4491 | 14.2 | 24.8 | 0.10 |
| 25 | 679 | 0.41 | 30.3 | 3980 | 18.0 | 30.1 | 0.10 |
| 50 | 673 | 0.39 | 31.3 | 4151 | 18.0 | 30.7 | 0.10 |
| 75 | 675 | 0.29 | 27.24 | 3700 | 17.4 | 31.5 | 0.10 |
| 100 | 672 | 0.36 | 22.3 | 3185 | 14.1 | 30.7 | 0.19 |

### Example II

### Preparation of Medium Density Board (MDF) with Corn Fibers

Medium density fiber boards (MDF) where prepared with a composition comprising 0 or 50% corn fibers, the rest consisting in poplar fibers. An adhesive compound consisting in 4.7% melamine urea-formaldehyde H-M01HT, 1% of wax and 9.8% humidity where added to wood fiber mixtures to give the 0% corn fiber content control, and 18.7% melamine urea-formaldehyde H-M01HT, 1% wax at 9.8% humidity for the 50% corn fiber content boards. The boards were prepared under pressure for a period of 240 sec. at 180° C.

Analysis were performed according to the ASTM D1037 test methods.

Table 2 shows the mean values of the different parameters tested for each concentration of corn fibers.

TABLE 2
Mean values of physical parameters of board prepared
with different concentrations of corn fibers.

| Concentration of | | Internal | Modulus of | Modulus of |
|---|---|---|---|---|
| corn fibers | Density | bounding | resistance | elasticity |
| (%) | (Kg/m³) | (MPa) | (MPa) | (MPa) |
| 0 | 803 | 1.391 | 42.6 | 3598 |
| 50 | 795 | 0.83 | 25.3 | 2581 |

### Example III

### Preparation of a High Density Fiber Board (HDF) with Corn Fibers

High density fiber boards were prepared with 10, 20, and 25% corn fibers, with the rest consisting in poplar fibers. An adhesive compound consisting in 12% melamine urea-formaldehyde, 0.9% wax and 9.4% was used. The boards were prepared under pressure for a period of 150 sec. at 180° C. for a target density of 900 kg/m³.

Analysis were performed according to the ASTM D1037 test methods.

Table 3 shows the mean values of the different parameters tested for each concentration of corn fibers.

TABLE 3
Mean values of physical parameters of board prepared
with different concentrations of corn fibers.

| Concentration of | | Modulus of | Modulus of |
|---|---|---|---|
| corn fibers | Density | resistance | elasticity |
| (%) | (Kg/m³) | (MPa) | (MPa) |
| 10 | 838 | 40.6 | 4284 |
| 20 | 819 | 40.9 | 3607 |
| 25 | 796 | 29.6 | 3640 |

According to the examples given above, it appears that composite boards, OSB, as well as MDF or HDF, can be made with different contents of non-wood plant fibers. Moreover, the composite boards produced in the above examples meet most of the building material standards in most countries.

While the invention has been described in connection with specific embodiments thereof, it will be understood that it is capable of further modifications and this application is intended to cover any variations, uses, or adaptations of the invention following, in general, the principles of the invention and including such departures from the present disclosure as come within known or customary practice within the art to which the invention pertains and as may be applied to the essential features hereinbefore set forth, and as follows in the scope of the appended claims.

We claim:

1. A composition for preparing a composite board, said composition comprising (i) non-wood plant particles, (ii) wood particles, and (iii) an adhesive component, said adhesive component being capable of binding said non-wood plant particles and said wood particles.

2. (canceled)

3. The composition of claim 1, wherein said composite board has a density of between about 100 to about 1,000 kg m³.

4. (canceled)

5. (canceled)

6. (canceled)

7. (canceled)

8. (canceled)

9. The composition of claim 1, wherein said non-wood plant particles have a density of between about 0.15 to about 1 g/cm³.

10. The composition of claim 1, wherein said composite board has an internal bonding strength of between about 0.5 to about 1 MPa.

11. The composition of claim 1, wherein said composite board has a modulus of rupture of between about 10 to about 60 MPa.

12. The composition of claim 1, wherein said composite board has a modulus of elasticity of between about 1,000 to about 7,000 MPa.

13. The composition of claim 1, wherein said composite board has a thick swelling index of between about 1 to about 20%.

14. (canceled)

15. The composition of claim 1, wherein said composite board has a water absorption index of between about 1 to about 40%.

16. (canceled)

17. The composition of claim 1, wherein said composite board has a linear expansion index of between about 0.05 to about 0.5%.

18. The composition of claim 1, wherein said non-wood plant particles originate from a source selected from the group consisting of abaca, hemp, agel, gebang palm, bagasse, sugar cane, bamboo, banana leaf, banana stem, caranguata, caroa, coir, coconut, corn, cotton, esparto grass, flax, giant reed, henequen, maguey, cantala, zapupe, Salvador sisal, Mexican sisal, sasal, hesperaloe, jusi, jute, kapok, kenaf, mautirius hemp, pipeira, fique, milkweed, New Zealand hemp, olona, papyrus, piassaya, para grass, ramie (china grass), rice, sunn, switchgrass, tata cloth, wheat, barley, straw, oat, grain sorghum, amaranth, and a cereal straw.

19. (canceled)

20. The composition of claim 1, wherein said wood particles comprise a lignocellulosic material.

21. The composition of claim 1, wherein said adhesive component comprises a formaldehyde derivative adhesive or an isocyanate resin.

22. The composition of claim 1, wherein said adhesive component comprises between about 1 to about 10% of a wax (w/w).

23. The composition of claim 1, wherein the proportion of said adhesive component in said composition is between about 1 to about 20%.

24. The composition of claim 1, wherein said composition has a humidity index of about 2 to about 20% before pressing said composition into a mat.

25. (canceled)

26. A composition for preparing composite board, said composition comprising:
non-wood plant particles, said non-wood plant particles (a) being in proportion of 1 to 99% with respect to the total particles content of said composite board and (b) having a density of between about 0.15 to about 1 g/cm³,
wood particles, said wood particles comprising a lignocellulosic material, and
an adhesive component capable of binding said non-wood plant particles and wood particles,
wherein said adhesive component (a) comprises a formaldehyde derivative adhesive or a isocyanate resin, (b) is in proportion of between about 1 to about 20% with respect to said composition, (c) comprises about 1 to about 10% (w/w) of a wax, and
wherein said composite board has (a) a density of between about 100 to about 1,000 kg m³, (b) an internal bonding of between about 0.5 to about 1 MPa, (c) a modulus of rupture of between about 10 to about 60 MPa, (d) a modulus of elasticity of between about 1,000 to about 7,000 MPa, (e) a thick swelling index of between about 1 to about 20%, (f) a water absorption of between about 1 to about 20%, (g) and a linear expansion index of between about 0.05 to about 0.5%.

27. (canceled)

28. Use of the composition of claim 26 in the manufacture of a composite board.

29. A method of producing a composite board, said method comprising the steps of:
a) preparing a mat with a composition, said composition comprising non-wood plant particles, wood particles and an adhesive component capable of binding said non-wood plant particles and said wood particles; and
b) pressing said mat at a temperature and for a sufficient time to obtain a composite board.

30. (canceled)

31. The method of claim 29, wherein said composite board has a density of between about 100 to about 1,000 kg m³.

32. (canceled)

33. (canceled)

34. (canceled)

35. (canceled)

36. (canceled)

37. The method of claim 29, wherein the non-wood plant particles have a density of between about 0.15 to about 1 g/cm³.

38. The method of claim 29, wherein said composite board has an internal bonding strength of between about 0.5 to about 1 MPa.

39. The method of claim 29, wherein said composite board has a modulus of rupture of between about 10 to about 60 MPa.

40. The method of claim 29, wherein said composite board has a modulus of elasticity of between about 1,000 to about 7,000 MPa.

41. The method of claim 29, wherein said composite board has a thick swelling index of between about 1 to about 20%.

42. (canceled)

43. The method of claim 29, wherein said composite board has a water absorption index of between about 1 to about 40%.

44. (canceled)

45. The method of claim 29, wherein said composite board has a linear expansion index of between about 0.05 to about 0.5%.

46. The method of claim 29, wherein said non-wood plant particles originate from a source selected from the group consisting of abaca, hemp, agel, gebang palm, bagasse, sugar cane, bamboo, banana leaf, banana stems, caranguata, caroa, coir, coconut, corn, cotton, esparto grass, flax, giant reed, henequen, maguey, cantala, zapupe, Salvador sisal, Mexican sisal, sasal, hesperaloe, jusi, jute, kapok, kenaf, mautirius hemp, pipeira, fique, milkweed, New Zealand hemp, olona, papyrus, piassaya, para grass, ramie (china grass), rice, sunn, switchgrass, tata cloth, wheat, barley, straw, oat, grain sorghum, amaranth, and a cereal straw.

47. (canceled)

48. The method of claim 29, wherein said wood particles comprise a lignocellulosic material.

49. The method of claim 29, wherein said adhesive component comprises a formaldehyde derivative adhesive or an isocyanate resin.

50. The method of claim 29, wherein said adhesive component comprises between about 1 to about 10% of a wax (w/w).

51. The method of claim 29, wherein the proportion of said adhesive component in said composition is between about 1 to about 20%.

52. The method of claim 29, wherein said composition has a humidity index of between about 2 to about 20% before pressing said composition into a mat.

53. (canceled)
